(19) United States
(12) Patent Application Publication
(10) Pub. No.: US 2004/0264689 A1
(43) Pub. Date: Dec. 30, 2004

(54) Telephone equipped with speaker

(75) Inventor: Yoshimi Takahashi, Tokyo (JP)

Correspondence Address: MORGAN LEWIS & BOCKIUS LLP, 1111 PENNSYLVANIA AVENUE NW, WASHINGTON, DC, 20004, US

(73) Assignee: Uniden Corporation

(21) Appl. No.: 10/633,695

(22) Filed: Aug. 5, 2003

(30) Foreign Application Priority Data
Jun. 26, 2003 (JP) 2003-183335

(51) Int. Cl. H04M 1/00; H04M 9/00

(52) U.S. Cl. 379/433.02

(57) ABSTRACT

The object of the present invention is to improve convenience of a telephone equipped with a speaker. In order to attain this object, the telephone equipped with a speaker in accordance with the present invention comprises a telephone body and a speakerphone functional unit comprising a microphone and a speaker and capable of being detachably mounted on the telephone body. The speakerphone functional unit comprises a wireless unit, and exchange of voice signals and control signals with the telephone body is conducted via the wireless circuit. As a result, the speakerphone functional unit can be freely used anywhere, without selecting a special location therefor.

### BACKGROUND OF THE INVENTION

1. Field of the Invention

The present invention relates to a telephone equipped with a speaker, more particularly to improved technology for increasing the convenience of speakerphone functions.

2. Description of the Related Art

Cordless telephones for indoor communications are known in which a base set and/or a handset are provided with a speakerphone function. Providing a speakerphone function makes it possible to have a conversation without holding a handset. The speakerphone function in cordless telephones has been implemented by equipping a base set and/or handset with a microphone and a speaker.

However, because the base set has to be connected to a subscriber line and an external power source line, limitation is placed on the base set location. Therefore, positional limitation is placed on conversations using a speakerphone mounted on the base set. On the other hand, the size of a speaker in the handset is limited because of size and weight requirements, and a speaker sound volume identical to that of the base set is difficult to provide. Moreover, because the charge capacity of the handset is limited, temporal limitations were placed on the communication using the speakerphone.

### SUMMARY OF THE INVENTION

Accordingly, it is an object of the present invention to resolve the above-described problems and to improve the convenience of a telephone equipped with a speaker.

In order to attain this object the telephone equipped with a speaker in accordance with the present invention comprises a telephone body and a speakerphone functional unit comprising a microphone and a speaker and capable of being detachably mounted on the telephone body. Employing the configuration with detachable telephone body and speakerphone functional unit makes it possible to communicate using a speakerphone function, without placing limitation on a telephone installation site.

Preferably, each of the telephone body and the speakerphone functional unit is provided with a wireless unit for opening a wireless circuit there between when the two are detached from each other and conducting transmission and reception of voice signals and control signals. With such a configuration, communication can be conducted by moving the speakerphone functional unit freely from one place to another.

Preferably, wireless units installed in each of the telephone body and the speakerphone functional unit maintains a communication circuit by automatically opening a wireless circuit and conducting transmission and reception of voice signals and control signals when the telephone body and the speakerphone functional unit are detached during communication via the telephone equipped with a speaker. With such a configuration, conversation can be maintained without breaking the communication circuit, even when the speakerphone functional unit is detached during the conversation.

Preferably, the speakerphone functional unit conducts transmission and reception of voice signals and control signals in a state in which it is attached to the telephone body, via connection units of the speakerphone functional unit and the telephone body. With such a configuration, when the speakerphone functional unit is attached to the telephone body, the function thereof as a speakerphone is realized by conducting transmission and reception of voice signals and control signals between the speakerphone functional unit and the telephone body, without using the wireless circuit.

Preferably, the speakerphone functional unit comprises a secondary battery for supplying electric power to the microphone and the speaker. With such a configuration, an independent battery drive of the speakerphone functional unit is possible.

Preferably, the telephone body comprises a power unit for charging the secondary battery. Such a configuration provides for excellent convenience because the speakerphone functional unit is automatically charged when attached to the telephone body.

### BRIEF DESCRIPTION OF THE DRAWINGS

FIG. 1 is a functional block diagram of the cordless telephone of the present embodiment;

FIG. 2 is a plan view of a speakerphone functional unit; and

FIG. 3 is a side view of the speakerphone functional unit.

### DESCRIPTION OF THE PREFERRED EMBODIMENTS

The preferred embodiments of the present invention will be described below with reference to the drawings.

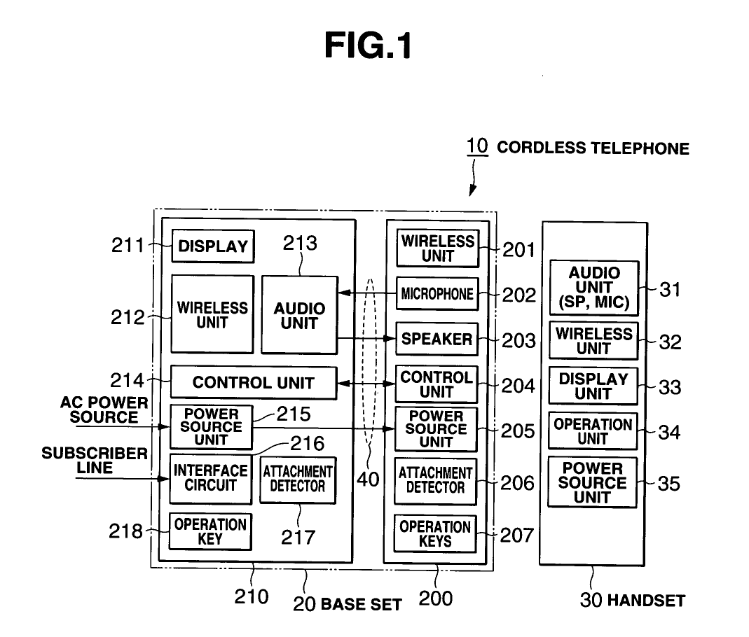

FIG. 1 is a functional block diagram of the cordless telephone of the present embodiment.

As shown in the figure, a cordless telephone 10 is composed of a base set 20 and a handset 30. The handset 30 is composed of an audio unit 31 comprising a microphone and a speaker to function as a speakerphone, a wireless unit 32 for wireless communication with the base set 20, a display unit 33 for displaying dial numbers and the like, operation keys 34 for inputting telephone number or the like, and a power source unit 35 comprising, for example, a secondary battery. The wireless unit 32 comprises a receiving unit and a transmitting unit comprising a synthesizer and a digital modem (not shown in the figure).

On the other hand, the base set 20 is a telephone equipped with a speaker, which is composed of a speakerphone functional unit 200 and a base set body (telephone body) 210. The speakerphone functional unit 200 is a functional unit comprising a microphone 202 and a speaker 203 as the main components and can be freely attached to and detached from the base set body 210 via a connection unit 40, for example, a connector. The speakerphone functional unit 200 is composed of a microphone 202 for inputting the caller's voice, a speaker 203 for amplifying the received voice and producing a loud-speaker output, a control unit 204 for conducting exchange of control signals with a control unit 214 of the base set body 210 via a control channel, a wireless unit 201 for conducting wireless communication with the base set body 210, operation keys 207 for conducting key input, a power source unit 205 comprising a battery such as a secondary battery, and an attachment detector 206 for detecting the attachment of the speakerphone functional unit 200 to the base set body 210. The wireless unit 201 comprises a receiving unit and a transmitting unit comprising a synthesizer and a digital modem.

The base set body 210 is composed of an audio unit 213 for digitally processing the transmitted voice that was input in the microphone 202, amplifying the received voice, and loud-speaker outputting the amplified voice from the speaker 203, the control unit 214 for conducting exchange of control signals with the speakerphone functional unit 200 via a control channel, the wireless unit 212 for conducting wireless communication with the handset 30 or the speakerphone functional unit 200, operation keys 218 for conducting key input, a display 211 for displaying the dial number or the like, a power source unit 215 for distributing the powder supplied from an AC power source to each circuit, an interface circuit 216 connected to a subscriber line, and an attachment detector 217 for detecting the attachment of the speakerphone functional unit 200 and the base set body 210.

When the speakerphone functional unit is attached to the base set body 210, it functions as a usual speakerphone, and a person can speak over the phone, without holding the handset. At this time, transmission and reception of various signals (voice signals, controls signals) between the speakerphone functional unit 200 and the base set body 210 and power supply from the base set body 210 to the speakerphone functional unit 200 are conducted via the connection unit 40. More specifically, the microphone 202 and the speaker 203 and connected with the audio unit 213 to receive and transmit voice signals, and the control unit 204 is connected to the control unit 214 to receive and transmit control signals. The power source unit 205 receives power supply from the power supply unit 215 and accumulates power supplied to each circuit (wireless unit 201, microphone 202, and the like).

On the other hand, when the speakerphone functional unit 200 is detached from the base set body 210, the speakerphone functional unit 200 conducts transmission and reception of voice signals to and from the base set body 210 via a wireless circuit. More specifically, the transmission voice that was input in the microphone 202 is transmitted into the audio unit 213 via the wireless circuit, digitally processed and thereafter transmitted to the telephone receiver of the call receiving party. Furthermore, voice generated by the other party is transmitted from the audio unit 213 via the wireless circuit to the speakerphone functional unit 200 and loud-speaker output from the speaker 203. With such a configuration, communication becomes possible in any location, without any specific limitation, provided that the location of the speakerphone functional unit 200 allows for wireless communication with the base set body 210.

The speakerphone functional unit 200 and the base set body 210 are provided with respective attachment detectors 206, 217 for detecting the attachment state thereof. If the attachment detectors 206, 217 detect that the speakerphone functional unit 200 is detached from the base set body 210, the speakerphone functional unit 200 automatically opens the wireless circuit between itself and the base set body 210, and communication between the speakerphone functional unit 200 and the base set body 210 is established. As a result, even when the speakerphone functional unit 200 is detached during communication via the base set 20, the communication can be maintained using the speakerphone functional unit 200, without breaking the communication circuit. Obviously, when the speakerphone functional unit 200 is attached to the base set body 210, a wireless circuit between the speakerphone functional unit 200 and the base set body 210 is disconnected, and the voice signals and control signals are transmitted and received directly via the connection unit 40.

A microphone and a speaker identical in size to those that have been installed in the conventional base sets can be directly used as the microphone 202 and the speaker 203. Therefore, the speaker sound volume of the speakerphone functional unit 200 detached from the base set body 210 is identical to the speaker sound volume obtained when the speakerphone functional unit is arranged on the base set body 210. Furthermore, because the power source unit 205 is charged to a capacity sufficient to conduct wireless communication over a sufficiently long time, an independent battery drive is possible and communication performance identical to that of the speakerphone of the conventional base set is ensured.

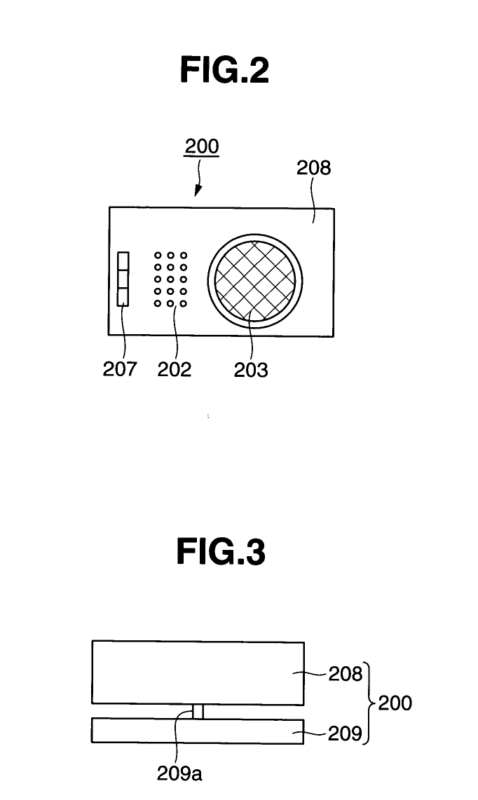

FIG. 2 is a plan view of the speakerphone functional unit 200. FIG. 3 is a side view of the speakerphone functional unit. As shown in FIG. 2, a body unit 208 constituting the main part of the speakerphone functional unit 200 has the microphone 202, the speaker 203, and the operation keys 207 provided therein. Further, as shown in FIG. 3, the body unit 208 is rotatably supported on a rotary shaft 209a with respect to a base 209, thereby allowing the orientation of the microphone 202 and the speaker 203 to be varied freely. With such a configuration, even when the directional microphone 202 and speaker 203 are used, for example, conversation can be conducted with good sensitivity if a large number of people change appropriately the orientation of the microphone 202 and speaker 203 in a conference room or the like.

As described hereinabove, in accordance with the present embodiment, the speakerphone functional unit 200 is constructed to be detachable from the base set body 210 and wireless communication with the base set body 210 is enabled, while allowing for an independent battery drive. As a result, the speakerphone functional unit 200 can be used without placing limitation on the lay-out location of the subscriber line. Furthermore, the telephone is very convenient because the base set 20 can be used as the usual speakerphone when the speakerphone functional unit 200 is attached to the base set body 210. Moreover, if detachment of the speakerphone functional unit 200 and the base set body 210 is detected with the attachment detectors 206, 217, even during the conversation via the base set 20, a wireless circuit is automatically opened therebetween and transmission and reception of voice signals can be conducted, thereby providing for excellent convenience.

What is claimed is:

1. A telephone equipped with a speaker, comprising a telephone body and a speakerphone functional unit comprising a microphone and a speaker and capable of being detachably mounted on said telephone body.

2. The telephone equipped with a speaker according to claim 1, wherein each of said telephone body and said speakerphone functional unit is provided with a wireless unit for opening a wireless circuit therebetween and conducting transmission and reception of voice signals and control signals when the two are detached from each other.

3. The telephone equipped with a speaker according to claim 2, wherein said wireless units carried by each of said telephone body and said speakerphone functional unit maintain a communication circuit by automatically opening a wireless circuit and conducting transmission and reception of voice signals and control signals when said telephone body and said speakerphone functional unit are detached during communication via said telephone equipped with a speaker.

4. The telephone equipped with a speaker according to any claim of claims 1 to 3, wherein in a state in which said speakerphone functional unit is attached to said telephone body, transmission and reception of voice signals and control signals is conducted via the connection units of the speakerphone functional unit and the telephone body.

5. The telephone equipped with a speaker according to claim 1, wherein said speakerphone functional unit comprises a secondary battery for supplying electric power to said microphone and speaker.

6. The telephone equipped with a speaker according to claim 5, wherein said telephone body comprises a power unit for charging said secondary battery.
